(19) United States
(12) Patent Application Publication
(10) Pub. No.: US 2010/0092165 A1
(43) Pub. Date: Apr. 15, 2010

(54) CAMERA SUPPORT HEAD FOR MOTION PICTURE, TV AND LIKE SHOOTINGS

(75) Inventors: Guido Cartoni, Rome (IT); Domenico Macchia, Rome (IT)

Correspondence Address: GAUTHIER & CONNORS, LLP, 225 FRANKLIN STREET, SUITE 2300, BOSTON, MA, 02110, US

(73) Assignee: CARTONI S.P.A., Rome (IT)

(21) Appl. No.: 12/565,816

(22) Filed: Sep. 24, 2009

(30) Foreign Application Priority Data
Oct. 3, 2008 (IT) RM2008A000526

(51) Int. Cl. G03B 17/00

(52) U.S. Cl. 396/428

(57) ABSTRACT

The present invention relates to a camera support head (1) for motion picture, TV and like shootings, comprising an L shake structure, comprising a first horizontal arm (2), that is rotatably coupled along a 360° arc (pan plane) about a first vertical axis (A), with a support element (3), such as a tripod, a dolly and like, and a second vertical arm (4), coupled at the bottom with said first horizontal arm (2), and bearing above a camera support bracket (5), said camera support bracket (5) being coupled with said second vertical arm (4) so as to be able to rotate along a 360° arc (tilt plane), said support head (1) being characterized in that coupling between said first horizontal arm (2) and said second vertical arm (4) permitting rotation each other along a 360° arc, about a second vertical axis (C), offset and parallel with respect to said first vertical axis (A), said rotation being adjustable and fixable.

### PRIORITY INFORMATION

The present application claims priority to Italian Patent Application No. RM2008A000526, filed on Oct. 3, 2008, all of which is incorporated herein in its entirety.

### BACKGROUND OF THE INVENTION

The present invention relates to a camera support head for motion picture, TV and like shootings.

More specifically, the invention concerns a camera support head of the above kind providing a further rotation freedom degree with respect to the heads presently available on the market.

L-type camera support heads are available on the market since many years, said heads permitting orientation both along the pan plane and along tilt plane.

Said heads provide an L shape bracket, with a first horizontal arm and a second vertical arm.

Said two arms are integrally coupled each other with a fixed angle of 90°.

First arm end not coupled with the second arm, is coupled with an element for rotation along pan plane, while on the second arm end not coupled with first arm is provided an element for rotation along tilt plane, a bracket being coupled to this last end, said bracket providing means for fixing the camera.

Thus, there are defined a first vertical axis, passing through said element for rotation along pan plane and through said first arm end coupled to the same, a second vertical axis, passing through the 90° coupling between said first and second arms, and a horizontal axis, about which said camera supporting bracket rotates.

This kind of brackets presently available on the market permit a full rotation (360°) both along pan plane and along tilt plane.

However, useful rotation (in order to make artistically valid shootings) along this second plane is limited to an arc of 250°-270° since, when camera is rotated downward, it will have the head support (tripod, dolly, ecc) within the shooting plane.

### SUMMARY OF THE INVENTION

The solution suggested according to the present invention permits solving the above mentioned drawback, by realizing a head of the above kind wherein it is provided a snood on the 90° coupling between said first arm and said second arm, so as to permit rotation of the camera along a second vertical axis (specifically the axis passing through the 90° coupling between said first arm and said second arm of the L shaped structure), which is offset and parallel with respect to the vertical axis passing through the element for rotation along pan plane.

It is therefore specific object of the present invention a camera support head for motion picture, TV and like shootings, comprising an L shake structure, comprising a first horizontal arm, that is rotatably coupled along a 360° arc (pan plane) about a first vertical axis, with a support element, such as a tripod, a dolly and like, and a second vertical arm, coupled at the bottom with said first horizontal arm, and bearing above a camera support bracket, said camera support bracket being coupled with said second vertical arm so as to be able to rotate along a 360° arc (tilt plane), said support head being characterized in that coupling between said first horizontal arm and said second vertical arm permitting rotation each other along a 360° arc, about a second vertical axis, offset and parallel with respect to said first vertical axis, said rotation being adjustable and fixable.

Furthermore, according to the invention, said rotation of said second vertical arm with respect to said first horizontal arm can be fixed in any point along the 360° arc.

Still according to the invention said rotation can be fixed according to set orientation points.

Always according to the invention, said rotation of said second vertical arm with respect to said first horizontal arm is obtained by a joint comprised of a first plate, integral with said first arm, and a second plate, integral with said second arm, fixing and releasing of rotation being obtained by fixing/release means.

Particularly, according to the invention, said fixing/release means are comprised of a screw, of a pin, of a snapping element and like.

Furthermore, according to the invention, rotation of said bracket with respect to said second vertical arm is obtained by a handle.

Still according to the invention, openings are provided in said first horizontal arm, in correspondence of said support element, in said second vertical arm, in correspondence of said support bracket, for passage of camera supply wires.

### BRIEF DESCRIPTION OF THE DRAWINGS

The present invention will be now described, for illustrative but not limitative purposes, according to its preferred embodiments, with particular reference to the figure of the enclosed drawings, wherein:

FIG. 1 is a perspective view of a head according to the invention;

FIG. 2 shows support head according to the invention in a first position;

FIG. 3 shows support head according to the invention in a second position;

FIG. 4 shows support head according to the invention in a third position; and

FIG. 5 shows support head according to the invention in a fifth position.

### DETAILED DESCRIPTION OF THE INVENTION

Observing now the figures of the enclosed drawings, it is shown a support head, generically indicated by reference number 1, having a L-shaped structure comprising a first arm 2, coupled in the example shown in the figures with a tripod 3, but that can be coupled with every kind of support employed in the TV or movie field for supporting cameras, and a second vertical arm 4, rotatably coupled with said arm 2.

Said arm 2 is coupled with said tripod 3 (or other kind of support) by an element (that will be not described in further detail since it is well known and it is not part of the invention) permitting its full rotation along plan plane, about vertical axis A.

Said second vertical arm 4 provides above the coupling with a bracket 5, so that the latter can rotate along a 360° on the tilt plane. Camera (not shown) will be coupled on said bracket 5. A handle 6 is provided in order to obtain rotation of bracket 5, along with the mounted camera.

It is confirmed once again that coupling between tripod 3 and first arm 2, permitting a rotation of the latter along a 360° arc about axis A, and between second arm 4 and bracket 5, permitting a 360° rotation along the tilt plane (about axis B) will be not further described in the following since they are not specific object of the present invention.

On the contrary, the innovative feature of the invention is the coupling between the first arm 2 and the second arm 4, realising together said substantially L-shaped structure, permitting a 360° rotation about vertical axis C, which is offset and parallel with respect to the first vertical axis A.

By joint, generically indicated by reference number 7, head 1 according to the invention permits, differently with respect to the known solutions, fully exploiting 360° rotation of camera (not shown) along tilt plane, since it permits bringing bracket 5 in an outer position with respect to axis A. Those skilled in the art will further understand that solution according to the invention permits exploiting camera mounted on head 1 in many ways and situations until now substantially impossible to obtain.

Just for example, it is easily possible mounting the head 1 on a support, such as a crane or like, with a reverse orientation, in order to make shootings skimming the water surface or the ground.

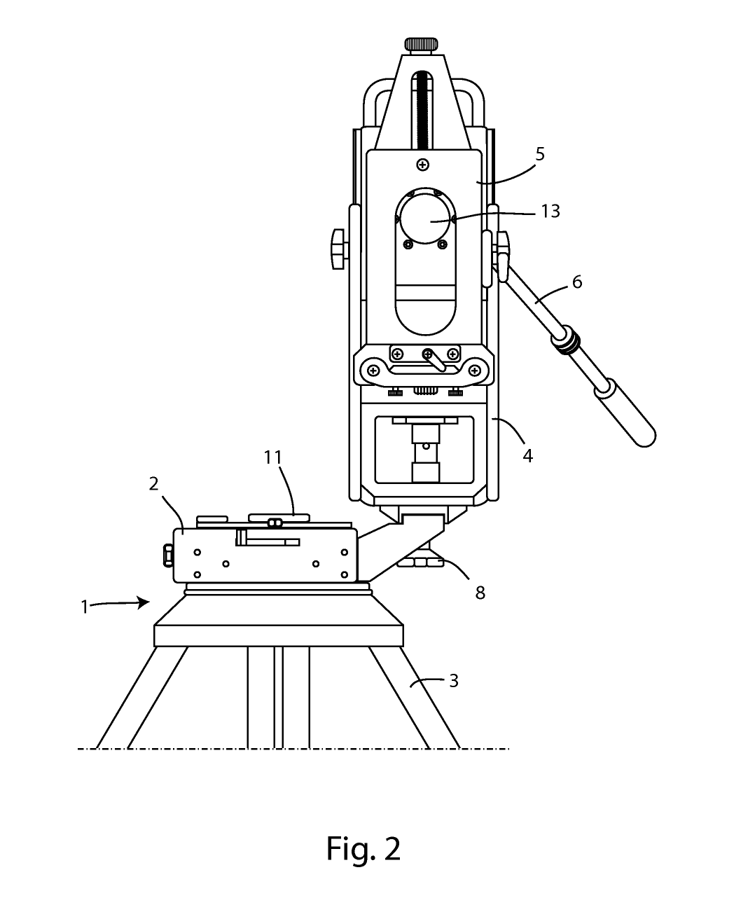

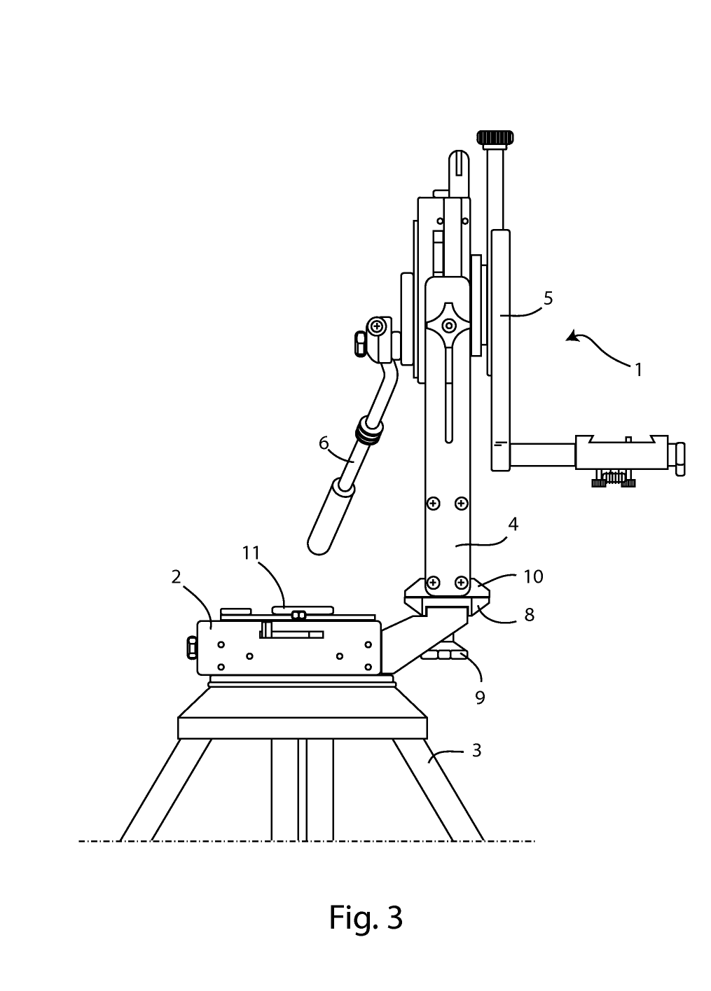

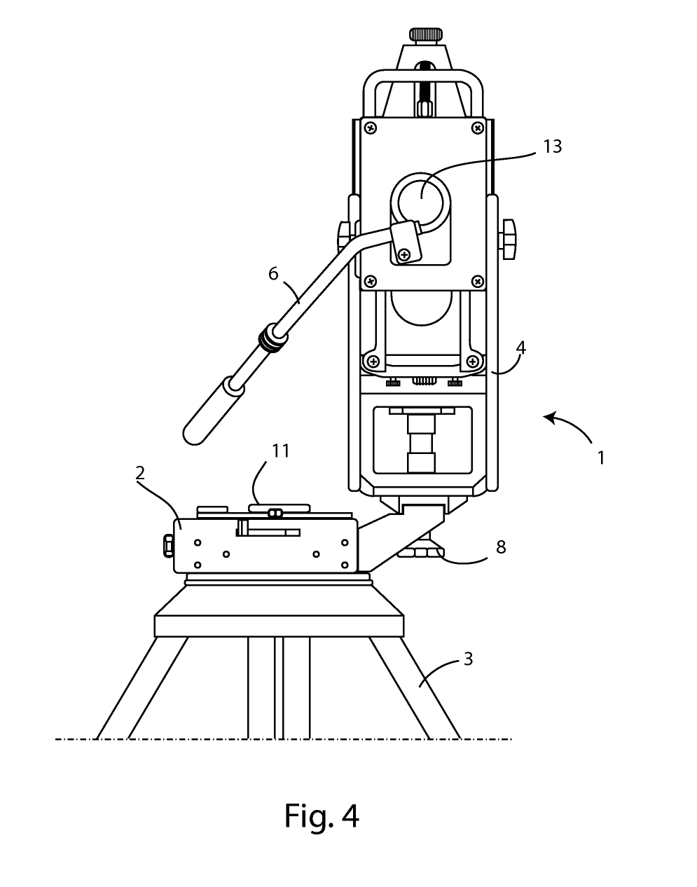

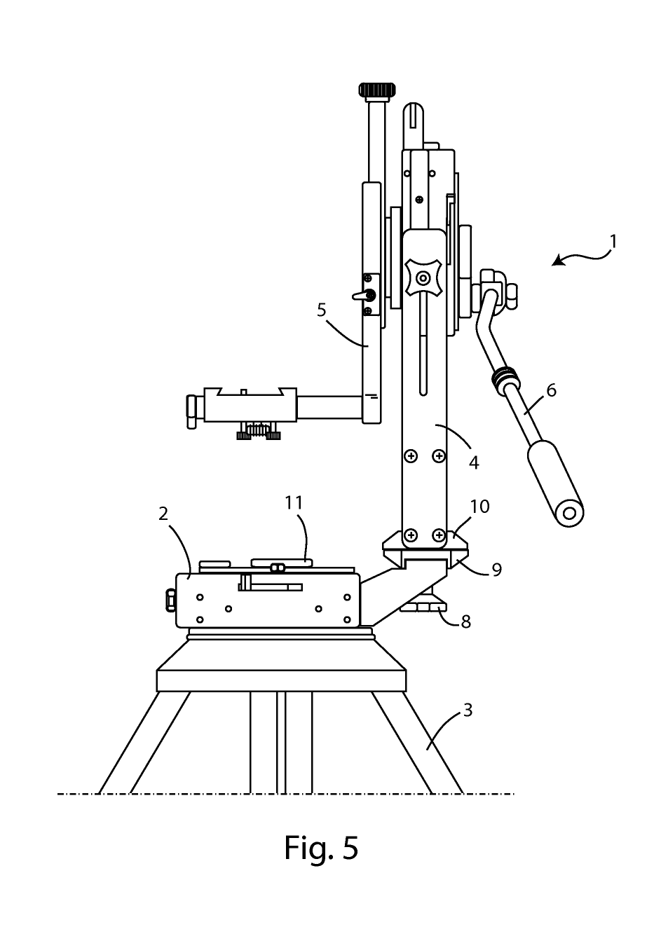

Particularly, it is noted from FIGS. 2-5, joint 7, providing a fixing/release screw 8, and two plates, respectively indicated by reference numbers 9, 10, provided on the first arm 2 and on the second arm 4. Two plates 9, 10 can be tightened by screw 8 when the wished orientation of the head 1 is obtained.

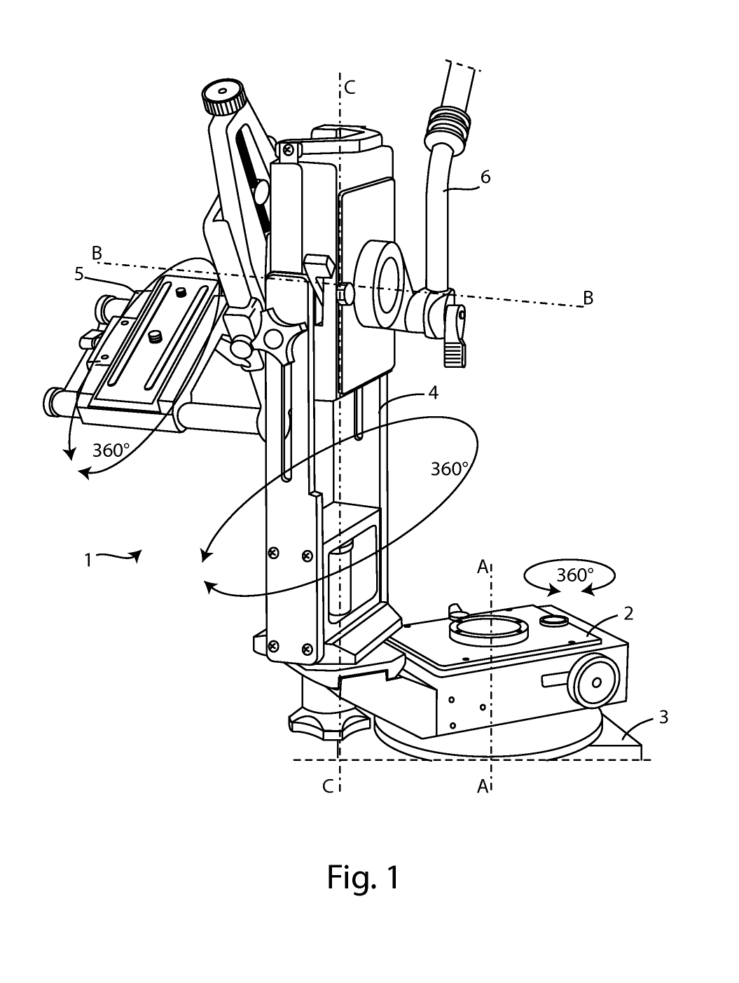

The four positions are shown in the above mentioned FIGS. 2-5, that are obtained by a variable orientation of 90°, until obtaining a full 360° rotation (see FIG. 1).

As already said, plates 9, 10 can provide coupling grooves in order to obtain automatic fixing of the position set orientation points.

However, the solution according to the present invention can permit each orientation along the 360° arc.

In the solution shown in the figures, first arm 2, second arm 4 and bracket 5 are provided with a hole, respectively holes 11, 12, and 13, for passage of camera electric supply cables, so as not to have any limitation to the rotation along every plane.

From the above short specification, it is understood that the solution according to the invention permits overcoming the drawbacks of the known solutions, realising a camera support without any limitation to the camera orientation.

The present invention has been described for illustrative but not limitative purposes, according to its preferred embodiments, but it is to be understood that modifications and/or changes can be introduced by those skilled in the art without departing from the relevant scope as defined in the enclosed claims.

What is now claimed:

1. A camera support head for motion picture, TV and like shootings, comprising an L shake structure, comprising a first horizontal arm, that is rotatably coupled along a 360° arc (pan plane) about a first vertical axis, with a support element, such as a tripod, a dolly and like, and a second vertical arm, coupled at the bottom with said first horizontal arm, and bearing above a camera support bracket, said camera support bracket being coupled with said second vertical arm so as to be able to rotate along a 360° arc (tilt plane), said support head being characterized in that coupling between said first horizontal arm and said second vertical arm permitting rotation each other along a 360° arc, about a second vertical axis, offset and parallel with respect to said first vertical axis, said rotation being adjustable and fixable.

2. The support head according to claim 1, wherein rotation of said second vertical arm with respect to said first horizontal arm can be fixed in any point along the 360° arc.

3. The support head according to claim 1, wherein said rotation can be fixed according to set orientation points.

4. The support head according to claim 1, wherein said rotation of said second vertical arm with respect to said first horizontal arm is obtained by a joint comprised of a first plate, integral with said first arm, and a second plate, integral with said second arm, fixing and releasing of rotation being obtained by fixing/release means.

5. The support head according to claim 4, wherein said fixing/release means are comprised of a screw, of a pin, of a snapping element and like.

6. The support head according to claim 1, wherein rotation of said bracket with respect to said second vertical arm is obtained by a handle.

7. The support head according to claim 1, wherein openings are provided in said first horizontal arm, in correspondence of said support element, in said second vertical arm, in correspondence of said support bracket, for passage of camera supply wires.
